(19) United States
(12) Patent Application Publication
(10) Pub. No.: US 2008/0050037 A1
(43) Pub. Date: Feb. 28, 2008

(54) IMAGE PROCESSING APPARATUS, COPYING SYSTEM, AND COMPUTER PROGRAM

(75) Inventors: Daisuke Sakiyama, Kawanishi-shi (JP); Yoichi Kawabuchi, Itami-shi (JP); Masahiro Kitamura, Osaka (JP); Kenichi Takahashi, Osaka (JP); Katsuhiko Akita, Amagasaki-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 11/843,463

(22) Filed: Aug. 22, 2007

(30) Foreign Application Priority Data
Aug. 23, 2006 (JP) 2006-226641

(51) Int. Cl. G06K 9/20

(52) U.S. Cl. 382/283

(57) ABSTRACT

An image processing apparatus is provided with an original data management portion that stores original image data for reproducing an original image, a mask extraction portion that acquires a mask image executed in the original image written on paper, and a printing unit that prints an image obtained by overlaying the original image and the mask image extracted by the extraction portion. The original image is reproduced based on the original image data, which is called from the original data management portion based on an identifier for identifying the original image written on that paper. Thus, it is possible to copy an original without causing image quality to deteriorate, and with information concealed.

This application is based on Japanese patent application No. 2006-226641 filed on Aug. 23, 2006, the contents of which are hereby incorporated by reference.

### BACKGROUND OF THE INVENTION

1. Field of the Invention

The present invention relates to an apparatus that performs processing for copying an original and to a method for copying an original.

2. Description of the Related Art

Recently, copy machines have become widespread, and it has become possible for anyone to simply copy an original. However, it is not possible to make a copy that is completely the same as an image of the original document. Accordingly, the image quality of the image of the copy is inferior to the image of the original document. Thus, when copying is performed based on that copy, it is only possible to obtain a copy whose image quality is further worsened.

So, two methods as stated below have been proposed. According to the first method, when recording image information to copy paper, a bar code of search information, which corresponds to the image information to be recorded, is recorded on the first page of copy paper. When an electronic copy machine captures that paper, the bar code is recognized, image information of the original with good image quality is read from a document server based on the recognized bar code, and printed.

According to the second method, in a document management system in which a server and a digital copy machine are connected such that they can communicate with each other, document data is associated with each document in the server, and document IDs are stored in a document ID table such that versions of the same document can be identified. The copy machine is provided with an image capturing portion that captures an original in which a document ID (a specific pattern) has been embedded, and a detection portion that detects the document ID from the captured image. The copy machine sends the detected document ID to the server. The server searches the document ID table based on the received document ID, and when there is a newer version than the read original, new document data is sent to the copy machine and printed.

In this manner, in the two methods, printing data is saved in the server. When copying a document, the copy machine downloads printing data corresponding to that document, and performs printing using that printing data. With such a configuration, it is possible to prevent deterioration in image quality due to copying.

Incidentally, there are cases in which a user needs to give a copy of an original to someone, but it is necessary to conceal a portion of the information in that original from the other person. In such a case, the original is copied after masking that portion by covering it in black.

However, when attempting to make a copy with high image quality using the two methods, a copy without masking is produced. Accordingly, if a copy with a portion of the original masked is desired, it is necessary to use a conventional method. Thus, only a copy with deteriorated image quality can be obtained.

### SUMMARY

The present invention was made in view of such problems, and it is an object thereof to enable copying of an original without causing image quality to deteriorate, and while concealing information.

According to one aspect of the present invention, an image processing apparatus connectable to an image capturing apparatus that captures an image written on paper, a printing apparatus that prints the image, and a storage apparatus that stores image data for reproducing an original image, the original image being an image of an original of a document, the image processing apparatus includes an image data acquisition portion that acquires the image data of the original image from the storage apparatus, based on an identifier for identifying the original image written on the paper, a mask image acquisition portion that acquires a mask image, the mask image being an image of a mask executed on the captured image, and a print controller that controls the printing apparatus so as to print an image obtained by overlaying the original image to be reproduced using the image data acquired by the image data acquisition portion and the mask image acquired by the mask image acquisition portion.

According to the structure described above, it is possible to copy an original without causing image quality to deteriorate, and with the reliability of information concealment improved over the conventional technology. Further, according to the structure described above, it is possible to easily manage the generations of a mask image.

### BRIEF DESCRIPTION OF THE DRAWINGS

FIGS. 1A and 1B show an example of the exterior and an example of the hardware configuration of an image processing apparatus.

FIG. 2 shows an example of a network configuration that includes an image processing apparatus.

FIG. 3 shows an example of the functional configuration of an image processing apparatus.

FIGS. 4A and 4B show an example of the positional relationship between an original image and a pattern image.

FIGS. 5A and 5B show an example of information displayed in a pattern image.

FIGS. 6A, 6B and 6C illustrate an example of a method for extracting a mask image.

FIGS. 7A and 7B illustrate an example of a method for removing a white outlined portion.

FIGS. 8A and 8B show an example of a mask information management table.

FIG. 9 is a flowchart that illustrates an example of the flow of an output original determination process.

FIG. 10 illustrates an example of a process for composing images for output.

FIGS. 11A, 11B, 11C and 11D illustrate an example of a method for extracting a mask image.

FIG. 12 is a flowchart illustrating an example of the overall flow of a copying process.

FIG. 13 is a flowchart illustrating a modified example of the flow of an output original determination process.

FIG. 14 illustrates an example of processing in an image processing apparatus when an original is given to multiple users and copied.

### DESCRIPTION OF THE PREFERRED EMBODIMENTS

The invention will now be described in detail with reference to the attached drawings.

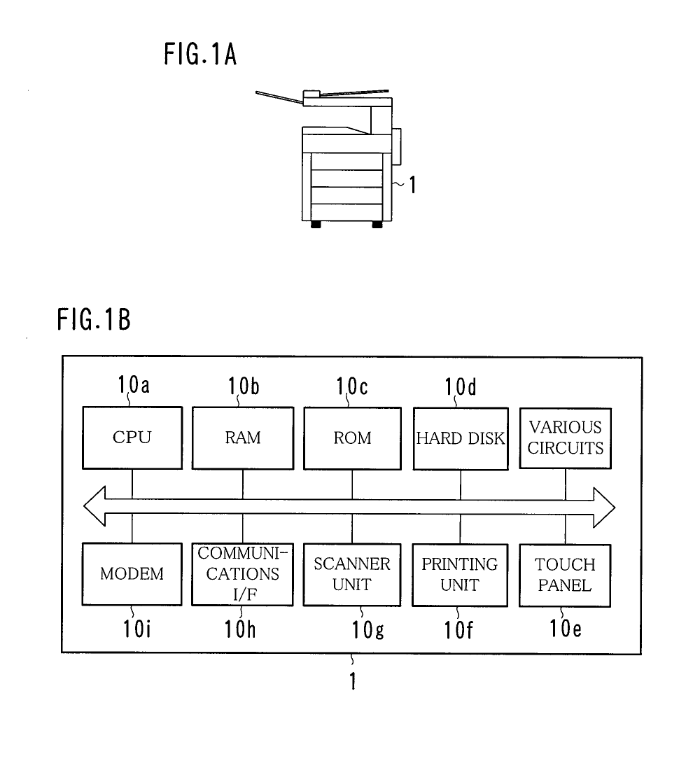

An image processing apparatus 1 has an exterior as shown in FIG. 1A, and is an image processing apparatus in which various functions are combined, such functions of copying, a scanner, a fax, network printing, a document server, and file transfer. This image processing apparatus may also be referred to as an image forming apparatus, a multi-function peripheral (MFP), or the like.

The image processing apparatus 1, as shown in FIG. 1B, is configured from a CPU 10a, a RAM 10b, a ROM 10c, a hard disk 10d, a touch panel 10e, a printing unit 10f, a scanner unit 10g, a communications interface 10h, a modem 10i, and various other circuits.

The touch panel 10e displays, for example, a screen for giving a message or instruction to a user, a screen for a user to input a desired type of processing and processing conditions, and a screen that displays the results of processing executed by the CPU 10a. Also, the user can give a command to the image processing apparatus 1, or designate processing conditions, by touching a predetermined position of the touch panel 10e. Thus, the touch panel 10e fulfills the role of a user interface for the user who operates the image processing apparatus 1.

The scanner unit 10g optically captures an image of an original recorded on paper, the original being configured from text, formulas, symbols, pictures, diagrams, illustrations, or the like, to generate image data.

The printing unit 10f forms an image based on image data obtained with the scanner unit 10g or based on a print job sent from a personal computer 3 or the like, and prints that image on paper.

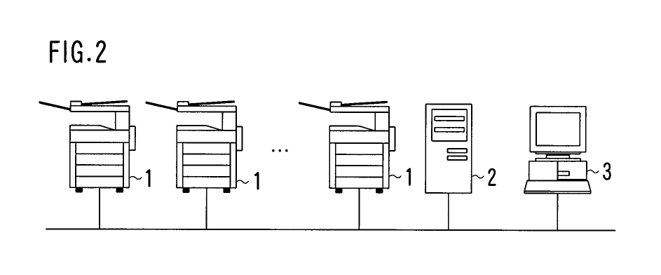

As shown in FIG. 2, the communications interface 10h is a network interface card (NIC) for connecting the image processing apparatus 1 itself to another image processing apparatus 1, a server 2, the personal computer 3, or the like via a communications circuit. The modem 10i is an interface for performing data communications with a fax terminal as a counterpart, using a fax protocol such as a G3 protocol.

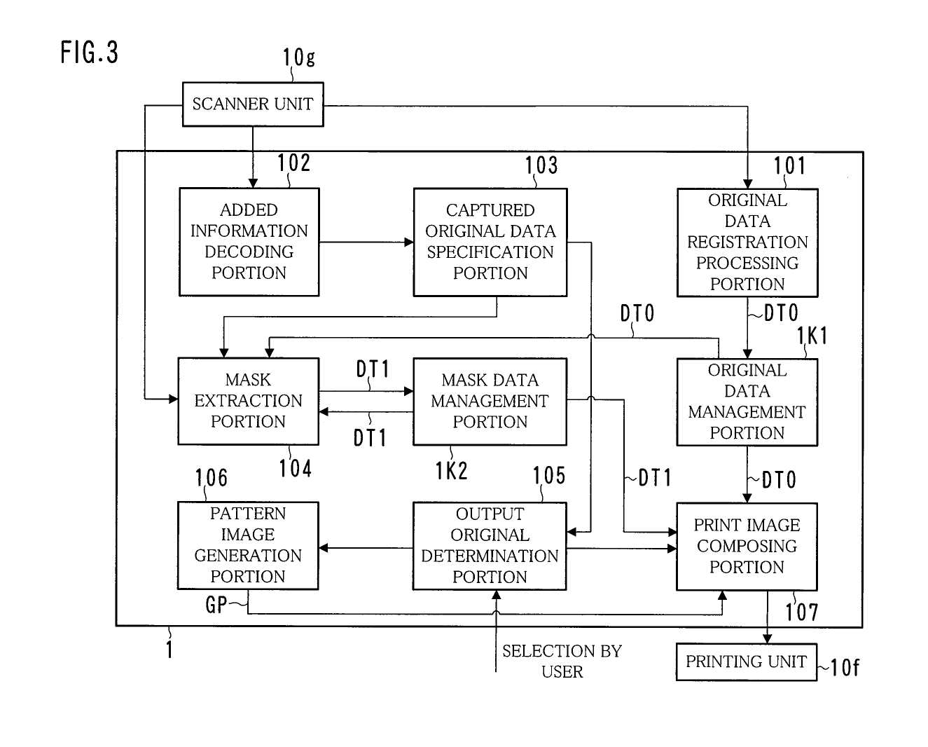

Installed on the hard disk 10d or in the ROM 10c are, as shown in FIG. 3, a program and data for realizing the functions of an original data registration processing portion 101, an added information decoding portion 102, a captured original data specification portion 103, a mask extraction portion 104, an output original determination portion 105, a pattern image generation portion 106, a print image composing portion 107, an original data management portion 1K1, a mask data management portion 1K2, and the like. As necessary, these programs and data are loaded into the RAM 10b, and the programs are executed by the CPU 10a.

With such a configuration, the image processing apparatus 1 can provide a user with a copy service in which the following functions (1) and (2) are applied.

(1) An image of an original (hereinafter, sometimes referred to as an “original image”) written on paper that has been read by the scanner unit 10g is copied without degradation. Thus, even if work to copy an original document image, and copy an original image of that copy, and further copy that copy, is performed, there is no deterioration of the original image. Below, in order to distinguish among original images printed one after another in this manner, an original document image may be referred to as a “first generation original image”, and a copy of an N-th generation original image may be referred to as an “N+1-th generation original image”. For example, a copy of a second generation original image may be referred to as a “third generation original image”, and a copy of a third generation original image may be referred to as a “fourth generation original image”.

(2) When performing copying in which the function of (1) above is applied, it is possible to copy together a masked portion executed on the paper on which the original image of the target of copying is written. That is, as described in the “Description of the Related Art”, according to the conventional methods, there was the problem that an image added to the paper is not copied. However, according to the image processing apparatus 1 of the present embodiment, it is possible to copy without removing the mask.

Following is a description of an arrangement in which the functions of (1) and (2) above are realized, with a description of the content of the processing of each portion of the image processing apparatus 1 shown in FIG. 3 broadly divided into processing for preparing original image data DT0, processing for copying a first generation original image, and processing for copying second generation or subsequent original images.

[Processing for Preparing Original Image Data DT0]

In FIG. 3, the original data management portion 1K1 saves and manages an original document image, that is, image data for reproducing a first generation original image. Below, the original document image is referred to as an “original image G0”, and image data for reproducing the original image G0 is referred to as “original image data DT0”. Specifically, the original data management portion 1K1 has a box (a storage region) for each user, and manages the original document image by attaching identification information (for example, a file name) for distinguishing that original image data DT0 from other original image data DT0, and saving to a box in the original data management portion 1K1. The “box” corresponds to a “folder” or a “directory” in a personal computer. Below, the identification information of the original image data DT0 is referred to as an “original ID”. The original ID is also used to identify the original image G0.

The original data registration processing portion 101 performs processing that generates new original image data DT0 and registers that original image data DT0 in the original data management portion 1K1. That processing is performed with the following procedure.

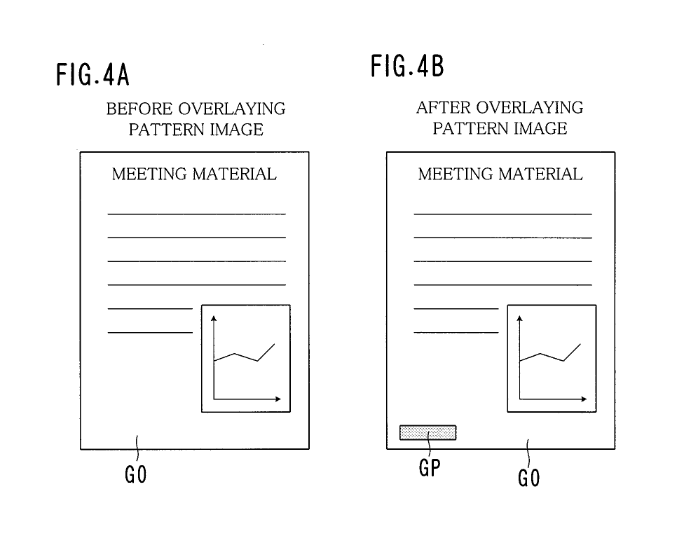

The user creates an original document as shown in FIG. 4A. For example, the user creates an original document by writing text, formulas, symbols, pictures, diagrams, illustrations, or the like on paper with a pen, and cutting and pasting. Also, an original document may be prepared by printing an original, the original created with application software of the personal computer 3 such as word processing software, spreadsheet software, drawing software, or the like, with the image processing apparatus 1 or another printing apparatus. A preexisting print may also be prepared as the original document.

The user logs in to the image processing apparatus 1 using his/her own user ID and password. Then, the user sets the paper on which an image of the created or prepared original document is written onto a platen glass of the image processing apparatus 1, and inputs a predetermined command to the touch panel 10e (see FIG. 1B).

Thus, the original data registration processing portion 101 controls the scanner unit 10g so as to obtain an image of the original document, i.e. image data of the original image G0, by capturing the image written on the entire face of that paper. By converting the obtained image data to a predetermined image format as necessary, the original image data DT0 is produced.

Then, the original data registration processing portion 101 issues an original ID for that original image data DT0, and determines the save location of that original image data DT0. In the present embodiment, the original data registration processing portion 101 saves the original image data DT0 in the box for the user (hereinafter, may be referred to as the “logged-in user”) that is presently logged in to the image processing apparatus 1 and performing work. Thus, the user that presently performed the work of registering the original image data DT0 is the owner of the original image data DT0. In that save location, that original image data DT0 is saved associated with its original ID and that user's user ID. With this processing, the processing that registers new original image data DT0 in a box in the original data management portion 1K1 is finished.

Further, the original data registration processing portion 101 performs processing to issue a pattern image GP to be added to the paper of that first generation original image.

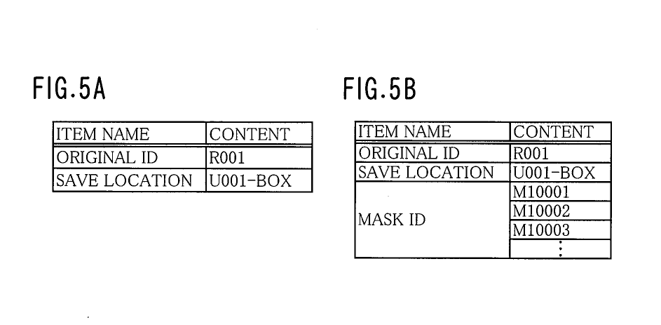

That is, the original data registration processing portion 101 requests that the pattern image generation portion 106 generate a pattern image GP for that first generation original image. When doing so, the pattern image generation portion 106 generates the pattern image GP, which expresses information of the items shown in FIG. 5A, i.e., the original ID and save location of the original image data DT0 for the original image issued by the original data registration processing portion 101.

Incidentally, this pattern image GP appears to human eyes as simply a pattern (a halftone dot pattern), but with the arrangement of the dots, a code is embedded that expresses both the original ID and the save location of the original image data DT0. Well-known electronic watermarking technology is used as the technology to generate and print the pattern image GP and the technology to capture and analyze the pattern image GP.

The usage method and the like for the pattern image GP are described in order below.

The original data registration processing portion 101 controls the printing unit 10f such that the original image G0 and the pattern image GP generated by the pattern image generation portion 106 are both printed arranged at predetermined positions on blank paper, as shown in FIG. 4B. Also, the pattern image GP may be directly printed at the predetermined position of the paper by manually supplying the captured paper to the printing unit 10f. Also, the pattern image GP alone may be printed on blank paper. In this case, the user pastes the print of the pattern image GP at a predetermined position of the paper containing the image of the original created or prepared by the user, as shown in FIG. 4B.

Paper to which the pattern image GP has been added in this manner is used as paper for the original document image, that is, paper for a first generation original image. The user can give this paper to another user or make a copy. This is described below.

Also, the original data registration processing portion 101 may perform processing that, with the following sort of procedure, registers the original image data DT0 in the original data management portion 1K1.

As the original image data DT0, the original data registration processing portion 101 inputs image data of an image of an original document in a predetermined format (for example, PDF or TIFF) that has been created with an application of the personal computer 3 such as word processing software, spreadsheet software, drawing software, or the like. The original data registration processing portion 101 issues an original ID for that original image data DT0, and determines that the logged-in user's box is the save location of that original image data DT0.

Then, that original image data DT0 is saved, associated with its original ID and the logged-in user's user ID, to that box in the original data management portion 1K1.

Afterward, when it is necessary for the logged-in user to give a print of that original image G0 to another user, the logged-in user operates the touch panel 10e to designate the save location (box) and original ID of the original image data DT0 of that original image G0, and to input a predetermined command.

When doing so, the pattern image generation portion 106 generates a pattern image GP that indicates that original ID and save location. The print image composing portion 107 calls the original image data DT0 corresponding to that original ID from that save location, converts the original image G0 into a bitmap image, places the pattern image GP at a predetermined position in the original image G0, and overlays the two images together. Then, the printing unit 10f prints those overlaid images on blank paper. A print obtained in this manner is also used as a print (paper) of a first generation original image.

[Processing to Copy First Generation Original Image]

A user in possession of a first generation original image, i.e., paper on which an original document image is written, can copy that paper using the image processing apparatus 1 and give that copy to another user. When the user copies that paper, information that the user does not want to show to the other user, or information that the other user does not need, can be masked by covering that information in black.

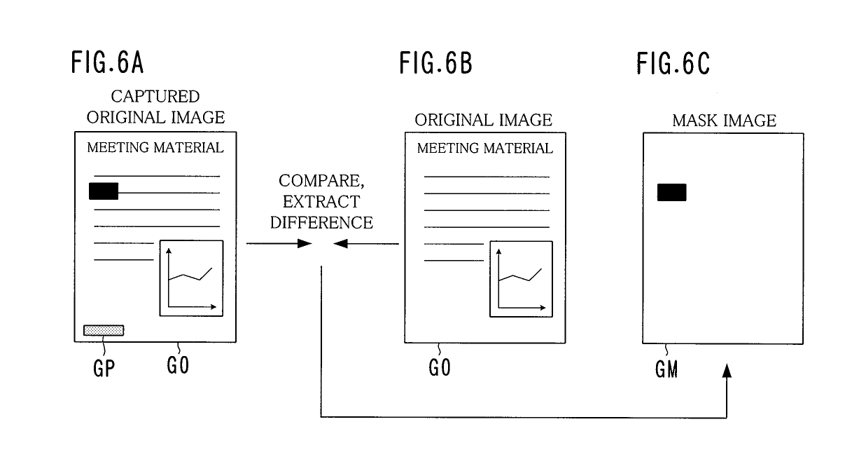

The user searches among the information written on the paper of the first generation original image for information that should be hidden, and masks that portion by covering it in black, as shown in FIG. 6A. Then, the user sets that paper on the platen glass of the image processing apparatus 1, and inputs a predetermined command to the touch panel 10e (see FIG. 1B).

When doing so, the scanner unit 10g acquires image data of an image in a state with a portion of the original image G0 covered with black and the pattern image GP added, by capturing the image written on the entire original face of that paper, i.e. a first generation original image.

The added information decoding portion 102 decodes added information expressed in that pattern image GP. As described previously with reference to FIG. 5A, the original ID and the save location are expressed in the pattern image GP added to the paper of a first generation original image. Thus, here, the added information decoding portion 102 decodes the original ID and the save location. Also, on the paper of a second generation or subsequent original image, one or a plurality of mask IDs may be expressed. This is described below.

Based on the original ID and save location decoded by the added information decoding portion 102, the captured original data specification portion 103 specifies the content of the image captured by the scanner unit 10g, i.e., the content written on the paper. Here, it is possible to specify at least that the original image G0 that corresponds to the original ID and is saved in that save location (box) is written.

The mask extraction portion 104 performs processing that extracts an image of the portion masked by the user. When copying a first generation original image, that processing is performed with a procedure as shown in FIGS. 6A-6C.

The mask extraction portion 104 calls the original image data DT0 of the original image G0 specified by the captured original data specification portion 103 (FIG. 6B).

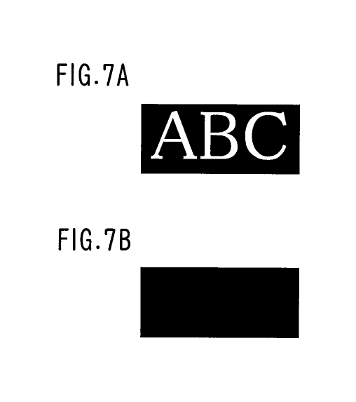

The original image G0 reproduced by the called original image data DT0 is compared with the image captured by the scanner unit 10g, and a difference image is extracted that expresses the difference between those two images. This difference image includes an image of a mask region constituted from a black area and an outline that expresses the information hidden by the user, as shown in FIG. 7A.

Then, as shown in FIG. 7B, that outline portion is replaced with the surrounding color, i.e., replaced with black. Thus, the outline in the mask region is masked. Thus, an image as shown in FIG. 6C is extracted. Below, this extracted image is referred to as a “mask image GM”.

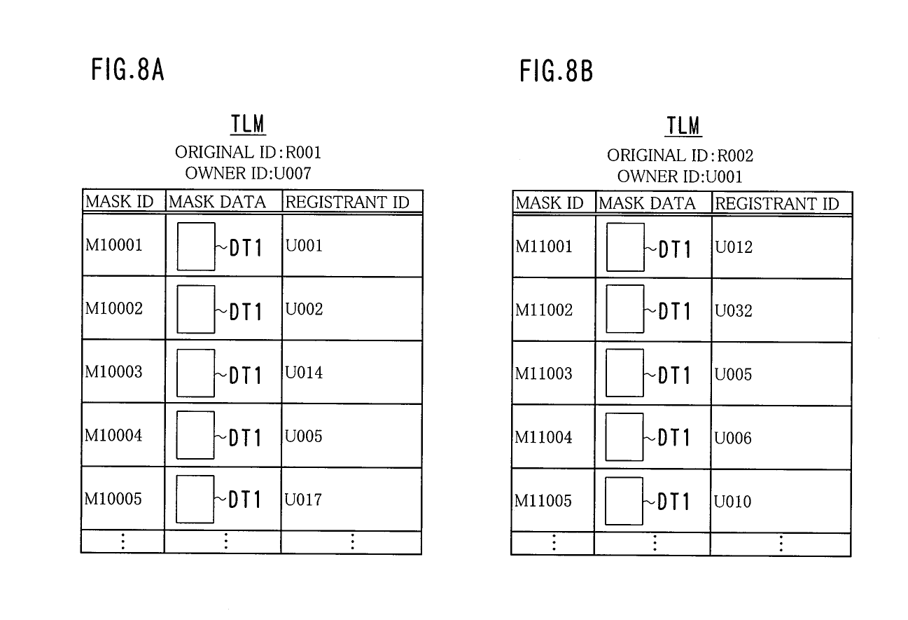

Returning to FIG. 3, the mask data management portion 1K2 includes a mask information management table TLM as shown in FIGS. 8A and 8B for each original image data DT0 managed by the original data management portion 1K1. The original ID of that original image data DT0 and the owner's user ID (owner ID) are associated with the mask information management table TLM.

The mask data management portion 1K2 stores and manages, as mask data DT1, the image data of the mask image GM extracted by the mask extraction portion 104 using the mask information management tables TLM.

For example, mask data DT1 of the mask image GM extracted by comparison with the original image data DT0, whose original ID is “R001”, is registered in the mask information management table TLM shown in FIG. 8A. At this time, the mask data management portion 1K2 issues a mask ID for that mask data DT1, and associates that mask ID with the user ID of the user who is the registrant.

The “mask ID” is identification information for distinguishing that mask data DT1 from other mask data DT1 that has already been registered. The mask ID can also be used to identify the mask image GM. The mask ID also fulfills the role of a sequence number (serial number), and a smaller number means that the corresponding mask data DT1 belongs to the mask for paper of an original image of an older generation. The “registrant” indicates the logged-in user who performed the operation to register the current mask data DT1.

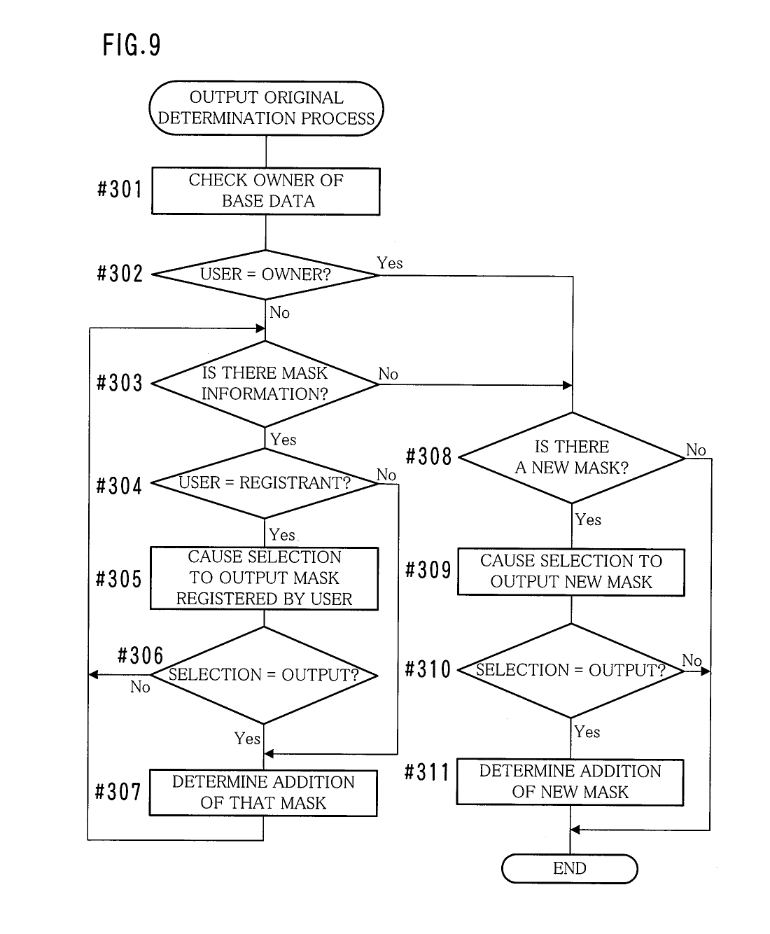

Returning to FIG. 3, according to a procedure as shown in the flowchart in FIG. 9, the output original determination portion 105 determines a mask image GM to be printed (outputted) onto paper together with the original image G0 in order to copy an N-th generation (here, first generation) original image.

In FIG. 9, the output original determination portion 105 checks the owner of the original image data DT0, which is the basis of the original image of the target of copying, based on the relationship between the original ID and owner ID (user ID) associated with each mask information management table TLM (see FIGS. 8A and 8B) (#301). That is, the output original determination portion 105 checks the owner of the original image data DT0 for the original ID decoded by the added information decoding portion 102.

When the logged-in user is not the owner, i.e., when the owner ID corresponding to the original ID decoded by the added information decoding portion 102 does not match the user ID of the current logged-in user (No in #302), if even one mask ID has been decoded by the added information decoding portion 102 from the pattern image GP, the processing in Steps #304 to #307 is performed. However, as stated above, in the case of the first generation, not even one mask ID is expressed in the pattern image GP. Thus, here, the processing in Steps #304 to #307 is skipped (No in #303).

When a new mask image GM has been extracted by the mask extraction portion 104 (Yes in #308), the output original determination portion 105 displays on the touch panel 10e a message that a selection should be made of whether to copy the original image with that mask image GM included, or to copy the original image without that mask image GM (#309). The user who has read that message selects from among those two alternatives.

Then, when the user has selected the former (Yes in #310), the output original determination portion 105 determines that the new mask image GM will be printed along with the original image G0 (#311).

When the owner of the original image data DT0 is the logged-in user as well (Yes in #302), the processing in Steps #304 to #307 is skipped, and the processing in Steps #308 to #311 is performed.

Returning to FIG. 3, the pattern image generation portion 106 newly generates a pattern image GP that expresses the original ID and save location decoded by the added information decoding portion 102, and the mask ID of the mask image GM determined by the output original determination portion 105. That is, the pattern image generation portion 106 generates a pattern image GP expressing contents as shown in FIG. 5B.

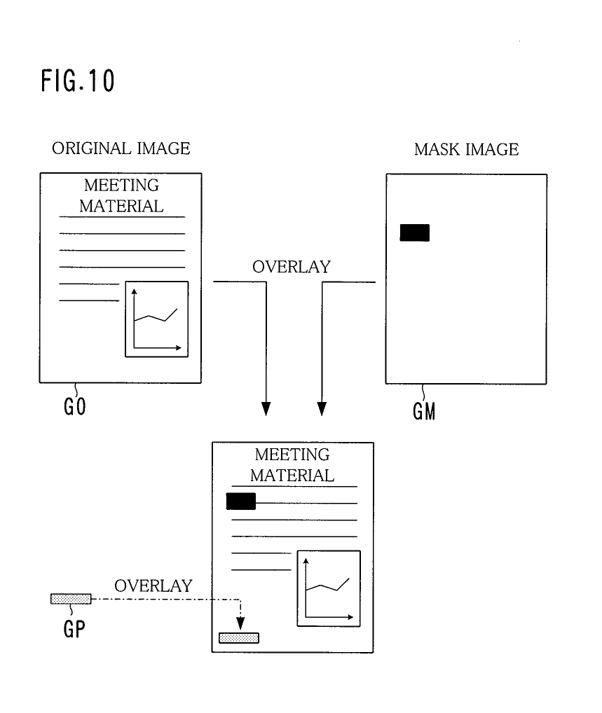

The print image composing portion 107, with a procedure as follows, performs processing that composes an image to be printed on blank paper. The print image composing portion 107 calls the original image data DT0 that corresponds to the original ID decoded by the added information decoding portion 102, and converts the original image G0 into a bitmap image based on that original image data DT0. The print image composing portion 107 calls the mask data DT1 of the mask image GM determined by the output original determination portion 105, and converts the mask image GM into a bitmap image based on that mask data DT1. Then, as shown in FIG. 10, the original image G0 and the mask image GM are overlaid together with their positions matched. Further, the pattern image GP is overlaid at a predetermined position.

The printing unit 10f prints the image generated (composed) by the print image composing portion 107 onto blank paper. Thus, a copy of a first generation original image is obtained. This copy is used as the print (paper) of a second generation original image.

[Processing for Copying Second Generation or Subsequent Original Image]

Same as in the case of copying a first generation original image, a user in possession of paper on which a second generation or subsequent original document image is written can copy that image onto blank paper using the image processing apparatus 1 and give that copy to another user. When the user copies that paper, information that the user does not want to show to the other user, or information that the other user does not need, can be masked by covering that information in black. Below, a description of points that duplicate the processing performed when copying a first generation original image are omitted here.

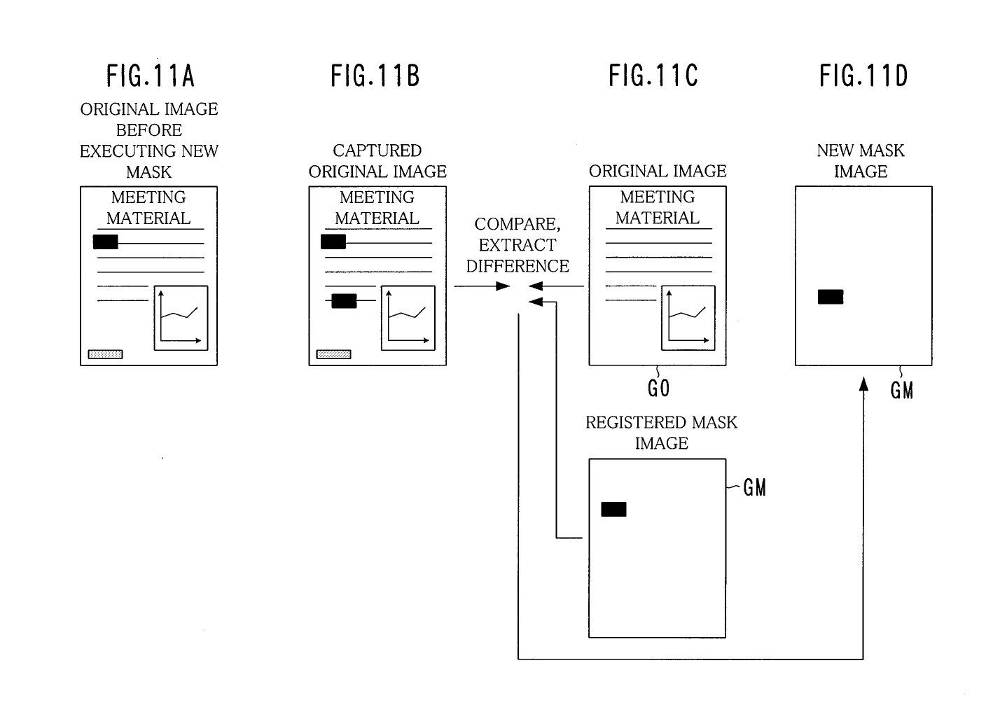

The user searches among the information written on the paper of an N-th (here, N≧2) generation original image as shown in FIG. 11A for information that should be hidden, and masks that portion by covering it in black, as shown in FIG. 11B. As shown in FIG. 11A, a mask that has already been executed may be included in a second generation or subsequent original image. Next, the user sets that paper on the platen glass of the image processing apparatus 1, and inputs a predetermined command to the touch panel 10e (see FIG. 1B).

When doing so, the scanner unit 10g acquires image data of the image written on the entire original face of that paper, by capturing that image.

The added information decoding portion 102 decodes the added information expressed in that pattern image GP, i.e., the original ID, the save location, and the mask ID.

Based on the original ID, the save location, and the mask ID decoded by the added information decoding portion 102, the captured original data specification portion 103 specifies the content of the image captured by the scanner unit 10g, i.e., the content written on the paper. Here, it is possible to specify at least that the original image G0 that corresponds to the original ID and is saved in that save location (box), and the mask image GM that corresponds to that mask ID, are written.

According to a procedure as shown in FIGS. 11B-11D, the mask extraction portion 104 performs processing that extracts an image of the portion that was newly masked at present by the user.

The mask extraction portion 104 calls the original image data DT0 of the original image G0 specified by the captured original data specification portion 103, and also likewise calls the mask data DT1 of all of the mask images GM specified by the captured original data specification portion 103 (FIG. 1C).

By comparing the original image G0 reproduced by the called original image data DT0 and all of the mask images GM reproduced by the mask data DT1 to the image captured by the scanner unit 10g, from within the image captured by the scanner unit 10g, an image is extracted of a portion that is not included in the original image G0 and any of those mask images GM. The extracted image includes an image constituted from a black area and an outline that expresses the information hidden by the user, as shown in FIG. 7A.

Then, as shown in FIG. 7B, that outline portion is replaced with the surrounding color, i.e., replaced with black, and thus a new mask image GM as shown in FIG. 11D is extracted.

The extracted new mask image GM receives issuance of a new mask ID, and is saved in the mask data management portion 1K2 associated with that mask ID and a registrant ID.

According to a procedure as shown in the flowchart in FIG. 9, the output original determination portion 105 determines a mask image GM to be printed (outputted) onto paper together with the original image G0 in order to copy the original image.

In FIG. 9, the output original determination portion 105 checks the owner of the original image data DT0 for the original ID decoded by the added information decoding portion 102 (#301).

When the logged-in user is not the owner (No in #302), the output original determination portion 105 determines, in the following manner, whether or not the mask image GM of each mask ID decoded by the added information decoding portion 102 is to be printed along with the original image G0.

The description now focuses on the mask image GM of the first mask ID. When the registrant of that mask image GM is the logged-in user, i.e., when the registrant ID for that mask image GM (see FIGS. 8A and 8B) matches the user ID of the logged-in user (Yes in #304), a message is displayed on the touch panel 10e that a selection should be made of whether to copy the original image with that mask image GM included, or to copy the original image without that mask image GM (#305). The user who has read that message selects from among those two alternatives. When the user has selected the former (Yes in #306), it is determined that the mask image GM will be printed along with the original image G0 (#307).

On the other hand, when the registrant of that mask image GM is not the logged-in user (No in #304), it is unconditionally determined that the mask image GM will be printed along with the original image G0 (#307).

When there are a plurality of mask IDs decoded by the added information decoding portion 102, it is likewise determined whether or not to print the mask image GM for the second and subsequent mask IDs along with the original image G0 (#304 to #307).

The processing in Steps #308 to #311 is performed as described above. That is, the logged-in user is caused to select whether or not to print the presently newly added mask image GM along with the original image G0. When the logged-in user has selected to print, the output original determination portion 105 determines to print that new mask image GM along with the original image G0.

When the owner of the original image data DT0 is the logged-in user (Yes in #302), the processing in Steps #303 to #307 is skipped, and the processing in Steps #308 to #311 is executed.

Returning to FIG. 3, the pattern image generation portion 106 and the print image composing portion 107, as described above, generate a pattern image GP based on the content determined by the output original determination portion 105, and generate (compose) an original image of the next generation. The printing unit 10f prints the image generated (composed) by the print image composing portion 107 on blank paper. Thus, a copy of an N-th generation original image is obtained. This copy is used as a print (paper) of an N+1-th generation original image.

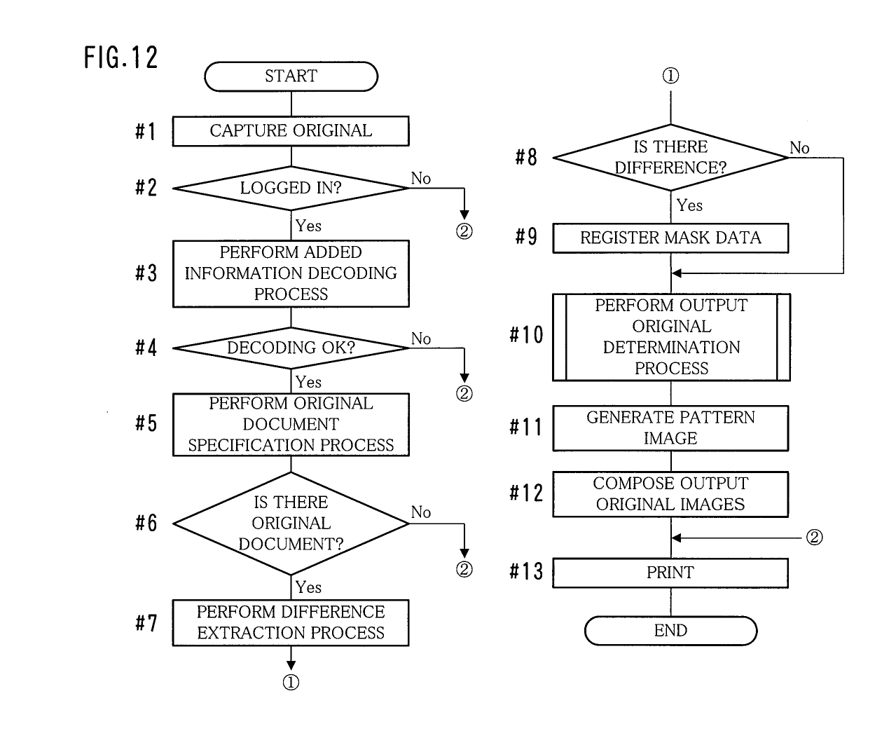

Next, the overall flow of processing for copying in the image processing apparatus 1 is described with reference to the flowchart in FIG. 12.

In FIG. 12, the image processing apparatus 1, by scanning the original face of the paper set on the platen glass, acquires image data of the original image written on the original face (#1).

When the user operating the image processing apparatus 1 is not logged in to the image processing apparatus 1 (No in #2), as with the conventional technology, the captured original image is printed to blank paper (#13). When the user operating the image processing apparatus 1 is logged in to the image processing apparatus 1 (Yes in #2), the processing of Step #3 and subsequent steps is performed.

That is, added information expressed by the pattern image GP included in the captured original image is decoded (#3). When the added information cannot be decoded, or when the pattern image GP is not included (No in #4), as with the conventional technology, the captured original image is printed onto blank paper (#13).

When it was possible to decode the added information (Yes in #4), the content of the captured original image is specified (#5). That is, what sort of original image G0 is the basis of that original image, and what sort of mask image GM is executed, are specified.

When the original image data DT0 of the specified original image G0 and the mask data DT1 of the specified mask image GM have not been saved (No in #6), as with the conventional technology, the captured original image is printed onto blank paper (#13).

When the original image data DT0 of the specified original image G0 and the mask data DT1 of the specified mask image GM have been saved (Yes in #6), an image of the portion covered by the user newly in order to presently perform the original image copy work, i.e., the new mask image GM, is extracted (#7). Then, when extraction is successful (Yes in #8), the mask data DT1 for that new mask image GM is registered in the mask data management portion 1K2 (see FIG. 8) (#9).

Processing that determines the mask image GM printed along with the original image G0 is performed (#10). The procedure for this processing is as described above with reference to FIG. 9.

A pattern image GP printed along with the original image G0 is generated (#11). Then, an image to be output is generated by overlaying the original image G0, the determined mask image GM, and the generated pattern image GP (#12), and printed onto blank paper (#13). With the above processing, the copy process finishes.

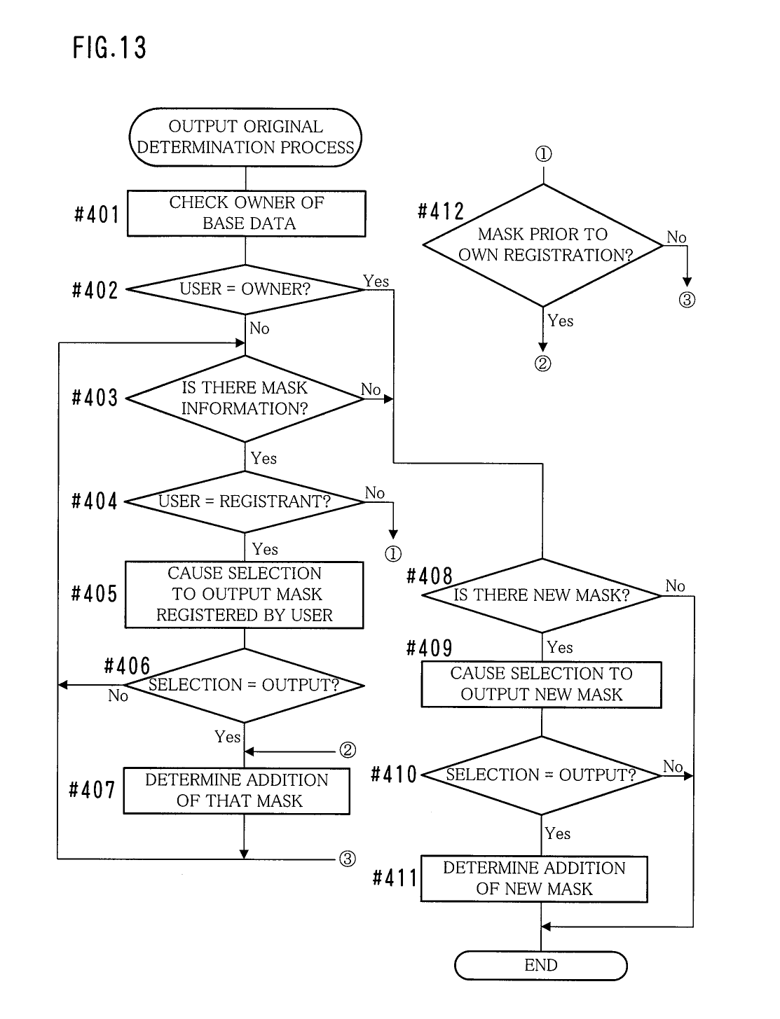

The output original determination process in Step #10 may be performed by a method as shown in FIG. 13 instead of the method described with reference to FIG. 9. In the method described with reference to FIG. 9, when the registrant of the mask image GM included in the captured original image is not the logged-in user, that mask image GM is unconditionally included in the print target (No in #304, #307 of FIG. 9). On the other hand, with the method shown in FIG. 13, if that mask image GM was already present when that logged-in user copied that original image in the past (Yes in #412), that mask image GM is included in the print target (#407), but if that mask image GM was added after that copying (No in #412), that mask image GM is not included in the print target.

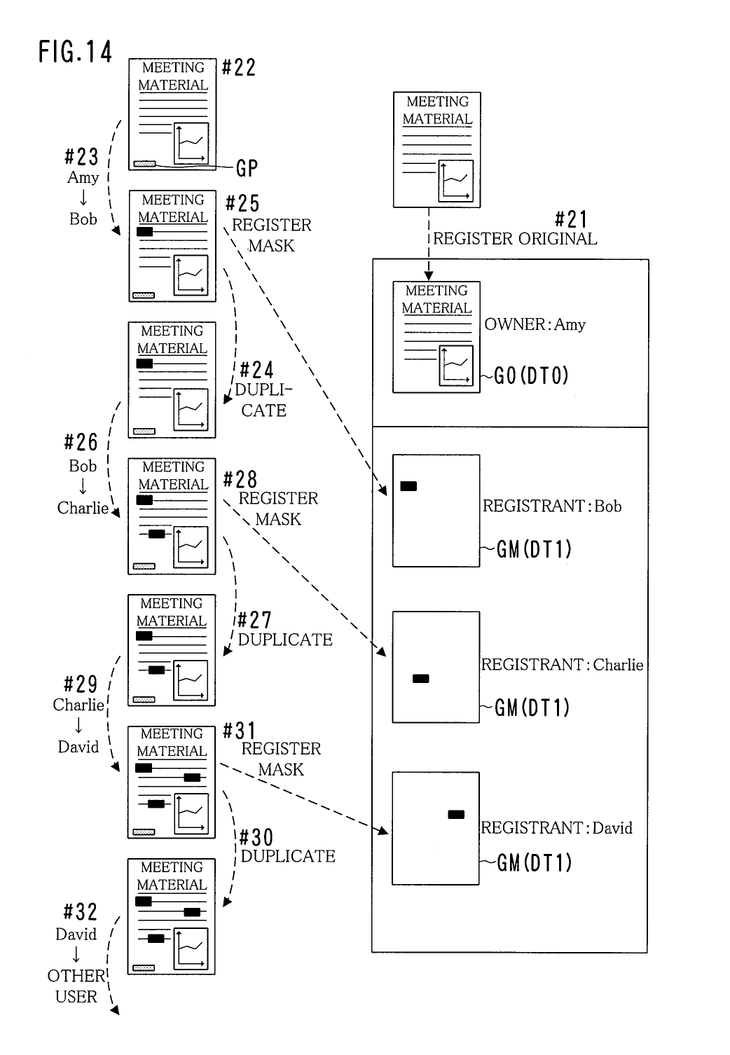

The other processing in FIG. 13, i.e., the processing content of Steps #401 to #403 and #405 to #411, is the same as Steps #301 to #303 and #305 to #311 in FIG. 9, so a description thereof is omitted here. An application example of the method in FIG. 13 is described next with reference to FIG. 14.

Here, the operation of the image processing apparatus 1 and the sort of print generated is described, taking by way of example a case in which material created by a user named “Amy” is successively copied and handed over to another user. Here, by way of example, a case is described in which the output original determination process is executed with the method in FIG. 13.

Amy creates handwritten material or creates material using the personal computer 3, and registers the original image data DT0 for that material in the image processing apparatus 1 (#21 in FIG. 14). At that time, the image processing apparatus 1 issues an original ID for that original image data DT0. Then, processing is performed in order to generate material with a pattern image GP added that expresses that original ID and the save location of the original image data DT0 (#22). At this point in time, even if someone causes the image processing apparatus 1 to copy that material, a copy that is the same as the original is obtained.

Amy causes the image processing apparatus 1 to copy that material, and gives the copied material to a user named “Bob” (#23).

Bob causes the image processing apparatus 1 to make a copy of the material received from Amy, in order to give a copy to a user named “Charlie” (#24). However, in order to not show Charlie a portion of the content of the material, the copy is made after covering that portion in black.

At this time, the image processing apparatus 1 extracts the mask image GM that expresses the present newly covered portion, and registers mask data DT1 for that mask image GM in the mask data management portion 1K2 (#25). Also, copying is performed after regenerating a pattern image GP with a mask ID for that mask image GM added.

Then, Bob gives that copied material to Charlie (#26). Afterward, Bob can again copy the material with the mask (cover) that he executed, or he can copy the material with the mask that he executed removed. Amy, who is the owner of that material, can copy that material with the mask removed (the original state of the material), based on the copy in Bob's possession.

Charlie causes the image processing apparatus 1 to make a copy of the material received from Bob, in order to give a copy to a user named “David” (#27). However, in order to not show David a portion of the content of the material, the copy is made after covering that portion in black.

At this time, the image processing apparatus 1, same as in the case of the processing in Step #25, extracts an image of the portion that was presently newly covered, and registers that image as a mask image GM (#28). Also, copying is performed after regenerating a pattern image GP with a mask ID for that mask image GM further added.

Then, Charlie gives that copied material to David (#29). Afterward, Charlie can again copy the material with the mask that he executed, or he can copy the material with the mask that he executed removed. However, Charlie cannot copy the material in a state with the mask previously executed by Bob removed. Amy, who is the owner of that material, can copy that material with the masks removed (the original state of the material), based on the copy in Charlie's possession. Bob can copy the material in a state with the mask presently executed by Charlie removed, based on the copy in Charlie's possession, and moreover Bob can copy the material in a state with the mask previously executed by Bob himself removed.

David causes the image processing apparatus 1 to make a copy of the material received from Charlie, in order to give a copy to another user (#30). However, in order to not show the other user a portion of the content of the material, the copy is made after covering that portion in black.

At this time, the image processing apparatus 1, same as in the case of the processing in Steps #25 and #28, extracts an image of the portion that was presently newly covered, and registers that image as a mask image GM (#31). Also, copying is performed after regenerating a pattern image GP with a mask ID for that mask image GM further added.

Then, David gives that copied material to another user (#32). Afterward, David can again copy the material with the mask that he executed, or he can copy the material with the mask that he executed removed. However, David cannot copy the material in a state with the masks previously executed by Bob and Charlie removed. Amy, who is the owner of that material, can copy that material with the masks removed (the original state of the material), based on the copy in David's possession. Bob can copy the material in a state with the mask presently executed by David and the mask previously executed by Charlie removed, based on the copy in David's possession, and moreover Bob can copy the material in a state with the mask previously executed by Bob himself removed. Charlie can copy the material in a state with the mask presently executed by David removed, based on the copy in David's possession, and moreover Charlie can copy the material in a state with the mask previously executed by Charlie himself removed. However, Charlie cannot copy the material in a state with the mask previously executed by Bob removed.

According to the present embodiment, it is possible to copy an original without causing image quality to deteriorate, and with information that should be concealed more reliably masked than with the conventional technology.

The copy processing of the present embodiment may be performed by the server 2 and a plurality of units of the image processing apparatus 1 in cooperation. For example, a configuration may be adopted in which the original data management portion 1K1 and the mask data management portion 1K2 in FIG. 3 are provided in the server 2, and the original image data DT0 managed with the original data management portion 1K1 and the mask data DT1 managed with the mask data management portion 1K2 are shared by a plurality of units of the image processing apparatus 1. Also, a configuration may be adopted such that all of the functions shown in FIG. 3 are provided in the server 2, and the image processing apparatuses 1 only perform processes for scanning and printing.

Also, when an original image scanned with a particular image processing apparatus 1 is printed with another image processing apparatus 1, the processing described with reference to FIG. 12 may be applied. In this case, the former image processing apparatus 1, i.e., the input-side image processing apparatus 1, performs the processing of Steps #1 to #12, and transmits the image data of the image obtained in Step #12 to the latter image processing apparatus 1, i.e., the output-side image processing apparatus 1. Then, the output-side image processing apparatus 1 performs the print processing of Step #13 based on the received image data. Also, the input-side image processing apparatus 1 performs the processing of Step #1, and transmits the image data of the obtained image to the output-side image processing apparatus 1. Then, the output-side image processing apparatus 1 performs the processing of Steps #3 to #13 using the received image data.

In the present embodiment, in Step #7 in FIG. 12, the mask image GM was extracted using the method described with reference to FIGS. 6A-6C or FIGS. 11A-11D, but extraction may be performed using another publicly known method. For example, the mask image GM may be extracted using the conventionally known black-covered region extraction method disclosed in WO 2005/002202 (Japanese unexamined patent publication No. 2005-20549).

In the present embodiment, a case was described by way of example in which the mask is performed with black, but the present invention is also applicable in a case in which the mask is performed with another color.

In addition, all or a part of, for example, the configuration of the image processing apparatus 1, the content of processing, the order of processing, the print position of the pattern image GP, and the configuration of tables may be appropriately modified in accordance with the gist of the present invention.

As discussed above, the invention according to independent claims of the present application can be embodied. Note that the embodiments described above also indicate image processing apparatuses in which the following features are incorporated.

The image processing apparatus further includes a mask information manager that manages mask information related to the mask image, and a mask image controller that controls the mask image to be overlaid with the original image and printed under the control of the print controller, based on the mask information managed by the mask information manager.

The image processing apparatus further includes a user identification portion that identifies a user who is using the image processing apparatus. The mask image controller selects the mask image to be overlaid with the original image and printed, that selection being based on the mask information and user information of the user identified by the user identification portion.

The mask image acquisition portion acquires the mask image by determining a mask region from a difference obtained by comparing the captured image to the original image to be reproduced based on the image data acquired by the image data acquisition portion, and masking an image included in the mask region.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An image processing apparatus connectable to an image capturing apparatus that captures an image written on paper, a printing apparatus that prints the image, and a storage apparatus that stores image data for reproducing an original image, the original image being an image of an original of a document, the image processing apparatus comprising:
an image data acquisition portion that acquires the image data of the original image from the storage apparatus, based on an identifier for identifying the original image written on the paper;
a mask image acquisition portion that acquires a mask image, the mask image being an image of a mask executed on the captured image; and
a print controller that controls the printing apparatus so as to print an image obtained by overlaying the original image to be reproduced using the image data acquired by the image data acquisition portion and the mask image acquired by the mask image acquisition portion.

2. The image processing apparatus according to claim 1, further comprising:
a mask information manager that manages mask information related to the mask image; and
a mask image controller that controls the mask image to be overlaid with the original image and printed under the control of the print controller, based on the mask information managed by the mask information manager.

3. The image processing apparatus according to claim 2, further comprising:
a user identification portion that identifies a user who is using the image processing apparatus,
wherein the mask image controller selects the mask image to be overlaid with the original image and printed, that selection being based on the mask information and user information of the user identified by the user identification portion.

4. The image processing apparatus according to claim 1, wherein the mask image acquisition portion acquires the mask image by determining a mask region from a difference obtained by comparing the captured image to the original image to be reproduced based on the image data acquired by the image data acquisition portion, and masking an image included in the mask region.

5. A copying system comprising:
an original image data storage portion that stores original image data, which is image data for reproducing an original image, the original image being an image of an original of a document;
an image capturing portion that captures the original image from paper;
an identification portion that identifies the original image written on the paper;
a mask image acquisition portion that acquires a mask image, the mask image being an image of a mask executed on the original image captured by the image capturing portion; and
a printer that prints an image obtained by overlaying the original image to be reproduced based on the original image data specified by the identification portion and the mask image acquired by the mask image acquisition portion.

6. The copying system according to claim 5, further comprising:
a mask image data storage portion that stores mask image data, which is image data of the mask image acquired by the mask image acquisition portion, associated with the original image in which the mask image has been executed,
wherein the mask image acquisition portion acquires, from within the mask image executed in the original image captured by the image capturing portion, only the mask image whose mask image data is not yet stored in the mask image data storage portion; and
the printer selectively prints the mask image, that has been previously acquired from the same original image by the mask image acquisition portion.

7. The copying system according to claim 6,
wherein the printer prints, along with the original image and the mask image, a code image that expresses an original identifier that is an identifier of the original image and a mask identifier that is an identifier of the mask image; and
the mask image acquisition portion acquires, from among the mask image executed in the original image captured by the image capturing portion, the mask image that cannot be reproduced based on any of the mask image data associated with the original image of the original identifier indicated in the code image captured along with the original image by the image capturing portion.

8. The copying system according to claim 7, wherein the image data storage portion stores, along with the mask image data, information for determining temporal relationship between a period in which the mask image for the mask image data was acquired and a period in which the mask image for other mask image data was acquired.

9. The copying system according to claim 5, further comprising:
a mask information manager that manages mask information related to the mask image; and
a mask image controller that controls the mask image to be overlaid with the original image and printed using the printer, based on the mask information managed by the mask information manager.

10. The copying system according to claim 9, further comprising:
a user identification portion that identifies a user who is using the copying system,
wherein the mask image controller selects the mask image to be overlaid with the original image and printed based on the mask information and user information of the user identified by the user identification portion.

11. The copying system according to claim 5, wherein the mask image acquisition portion acquires the mask image by determining a mask region from a difference obtained by comparing the captured image to the original image to be reproduced based on the image data acquired by the image data acquisition portion, and masking an image included in the mask region.

12. A copy method comprising:
storing original image data, which is image data for reproducing an original image, the original image being an image of an original of a document, in an original image data storage portion;
capturing the original image from paper;
performing identification of the original image written on the paper;
acquiring a mask image, the mask image being an image of a mask executed on the original image that was captured; and
printing an image obtained by overlaying the original image to be reproduced based on the original image data specified by the identification and the acquired mask image.

13. The copy method according to claim 12, further comprising:
managing mask information related to the mask image; and
performing control of the mask image to be overlaid with the original image and printed, based on the managed mask information.

14. The copy method according to claim 13, further comprising:
identifying a user who issues a copy command; and
selecting the mask image to be overlaid with the original image and printed, that selection being based on the mask information and user information of the identified user.

15. The copy method according to claim 12, further comprising:
acquiring the mask image by determining a mask region from a difference obtained by comparing the image captured from the paper to the original image to be reproduced based on the original image data specified by the identification, and masking an image included in the mask region.

16. A computer program embodied in a computer readable medium, the computer program used in a computer connectable to an image capturing apparatus that captures an image written on paper, a printing apparatus that prints the image, and a storage apparatus that stores image data for reproducing an original image, the original image being an image of an original of a document, the computer program allowing the computer to perform:
processing that acquires the image data of the original image from the storage apparatus, by identifying the original image written on the paper;
processing that acquires a mask image, the mask image being an image of a mask executed on the captured image; and
processing that controls the printing apparatus so as to print an image obtained by overlaying the original image to be reproduced using the image data acquired and the mask image acquired.

17. The computer program embodied in a computer readable medium according to claim 16, the computer program allowing the computer to further perform:
processing that manages mask information related to the mask image; and
processing that performs control of the mask image to be overlaid with the original image and printed based on the managed mask information.

18. The computer program embodied in a computer readable medium according to claim 17, the computer program allowing the computer to further perform:
processing that identifies a user who is using the computer; and
processing that selects the mask image to be overlaid with the original image and printed, that selection being based on the mask information and user information of the identified user.

19. The computer program embodied in a computer readable medium according to claim 16, the computer program allowing the computer to further perform processing that acquires the mask image by determining a mask region from a difference obtained by comparing the captured image to the original image to be reproduced based on the image data acquired, and masking an image included in the mask region.
